(19) United States
(12) Patent Application Publication
(10) Pub. No.: US 2021/0165772 A1
(43) Pub. Date: Jun. 3, 2021

(54) DISCOVERING AND MERGING ENTITY RECORD FRAGMENTS OF A SAME ENTITY ACROSS MULTIPLE ENTITY STORES FOR IMPROVED NAMED ENTITY DISAMBIGUATION

(71) Applicant: INTERNATIONAL BUSINESS MACHINES CORPORATION, ARMONK, NY (US)

(72) Inventors: CHRISTOPHER F. ACKERMANN, FAIRFAX, VA (US); CHARLES E. BELLER, Baltimore, MD (US); EDWARD G. KATZ, Washington, DC (US); MICHAEL DRZEWUCKI, Woodbridge, VA (US)

(21) Appl. No.: 16/702,513

(22) Filed: Dec. 3, 2019

(51) Int. Cl. G06F 16/215; G06F 40/295; G06F 16/28; G06F 16/2455; G06F 16/2457

(52) U.S. Cl. CPC G06F 16/215; G06F 40/295; G06F 16/24578; G06F 16/24565; G06F 16/288

(57) ABSTRACT

A service receives, from a query entity store, a query store result in response to an initial query referencing at least one of a name element and a first identifier component related to an entity, the query store result comprising a query store record comprising information related to the entity. The service receives, from a target entity store, a target store result to a target store query referencing the query store record, the target store result comprising one or more target store records related to the information found in the query store record. The service compares the one or more target store records to the information in the query store record. The service, responsive to determining a relevancy assessment indicates a match between the information in the query store record and two or more particular target store records from among the one or more target store records, triggers the target entity store to merge the two or more particular target store records.

This invention was made with United States Government support under contract number 2018-18010800001. The Government has certain rights in this invention.

### BACKGROUND

### 1. Technical Field

One or more embodiments of the invention relate generally to natural language processing and particularly to discovering and merging entity record fragments of a same entity across multiple entity stores for improved named entity disambiguation.

### 2. Description of the Related Art

With the increased usage of computing networks, such as the Internet, the amount of information that is available and categorized from structured and unstructured sources has also increased.

### BRIEF SUMMARY

In one embodiment, a method is directed to receiving, by a computer system, from a query entity store, a query store result in response to an initial query referencing at least one of a name element and a first identifier component related to an entity, the query store result comprising a query store record comprising information related to the entity. The method is directed to receiving, by the computer system, from a target entity store, a target store result to a target store query referencing the query store record, the target store result comprising one or more target store records related to the information found in the query store record. The method is directed to comparing, by the computer system, the one or more target store records to the information in the query store record. The method is directed to, responsive to determining a relevancy assessment indicates a match between the information in the query store record and two or more particular target store records from among the one or more target store records, triggering, by the computer system, the target entity store to merge the two or more particular target store records.

In another embodiment, a computer system comprises one or more processors, one or more computer-readable memories, one or more computer-readable storage devices, and program instructions, stored on at least one of the one or more storage devices for execution by at least one of the one or more processors via at least one of the one or more memories. The stored program instructions comprise program instructions to receive, from a query entity store, a query store result in response to an initial query referencing at least one of a name element and a first identifier component related to an entity, the query store result comprising a query store record comprising information related to the entity. The stored program instructions comprise program instructions to receive, from a target entity store, a target store result to a target store query referencing the query store record, the target store result comprising one or more target store records related to the information found in the query store record. The stored program instructions comprise program instructions to compare the one or more target store records to the information in the query store record. The stored program instructions comprise program instructions, responsive to determining a relevancy assessment indicates a match between the information in the query store record and two or more particular target store records from among the one or more target store records, to trigger the target entity store to merge the two or more particular target store records.

In another embodiment, a computer program product comprises one or more computer readable storage media having program instructions collectively stored thereon, wherein the one or more computer readable storage media are not a transitory signal per se. The program instructions are executable by a computer to cause the computer to receive, by a computer, from a query entity store, a query store result in response to an initial query referencing at least one of a name element and a first identifier component related to an entity, the query store result comprising a query store record comprising information related to the entity. The program instructions are executable by the computer to cause the computer to receive, by the computer, from a target entity store, a target store result to a target store query referencing the query store record, the target store result comprising one or more target store records related to the information found in the query store record. The program instructions are executable by the computer to cause the computer to compare, by the computer, the one or more target store records to the information in the query store record. The program instructions are executable by the computer to cause the computer to, responsive to determining a relevancy assessment indicates a match between the information in the query store record and two or more particular target store records from among the one or more target store records, trigger, by the computer, the target entity store to merge the two or more particular target store records.

### BRIEF DESCRIPTION OF THE SEVERAL VIEWS OF THE DRAWINGS

The novel features believed characteristic of one or more embodiments of the invention are set forth in the appended claims. The one or more embodiments of the invention itself however, will best be understood by reference to the following detailed description of an illustrative embodiment when read in conjunction with the accompanying drawings, wherein:

FIG. 1 illustrates a block diagram of one example of a disambiguation system for discovering and merging entity record fragments of a same entity across multiple entity stores for improved named entity disambiguation;

FIG. 2 illustrates an illustrative diagram of one example of a disambiguation system discovering and merging entity record fragments in a target store that map to a query store record for improved named entity disambiguation;

FIG. 3 illustrates an illustrative diagram of one example of a disambiguation system discovering and merging entity record fragments in a query store that map to a target store record for improved named entity disambiguation;

FIG. 4 illustrates a block diagram of one example of a computer system in which one embodiment of the invention may be implemented;

FIG. 5 illustrates a high-level logic flowchart of a process and computer program for managing an entity disambiguation by discovering and merging entity record fragments of a same entity across multiple entity stores;

FIG. 6 illustrates a high-level logic flowchart of a process and computer program for evaluating whether a query store record matches a target store record across multiple entity stores for managing entity disambiguation across multiple entity stores;

FIG. 7 illustrates a high-level logic flowchart of a process and computer program for managing a combination phase to coordinate triggering entity stores to internally evaluate merging records subsequent to a disambiguation system managing an externally triggered merging of records within the entity stores; and

FIG. 8 illustrates a high-level logic flowchart of a process and computer program for determining whether to trigger an additional iteration of a disambiguation evaluation for a current entity query.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In addition, in the following description, for purposes of explanation, numerous systems are described. It is important to note, and it will be apparent to one skilled in the art, that the present invention may execute in a variety of systems, including a variety of computer systems and electronic devices operating any number of different types of operating systems.

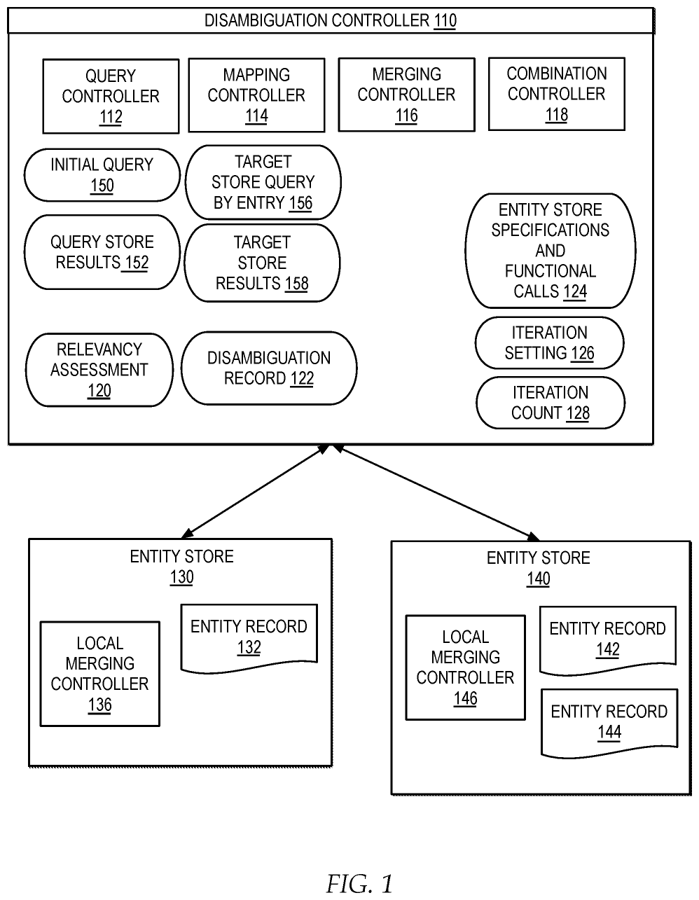

FIG. 1 illustrates a block diagram of one example of a disambiguation system for discovering and merging entity record fragments of a same entity across multiple entity stores for improved named entity disambiguation.

In one example, a merger controller 110 discovers and merges entity record fragments that refer to the same entity in separate entity stores, such as an entity store 130 and an entity store 140. In one example, an entity store represents a system to ingest, aggregate, and store information about real world entities, identified as named entities, for supporting named entity recognition (NER) and searching. In one example, each entity store may represent a separate database with a selection of implementation specifications and function interfaces. In one example, NER represents one or more types of information extraction that locate and classify named entities in text into categories, which may include pre-defined categories. The term “entity” may refer to one or more of people, places, companies, events, and concepts identifiable by a name element. The name element may include a single word or a string of words. NER may include entity identification, entity chunking, and entity extraction. Categories may include, but are not limited to, individuals, companies, places, organization, cities, dates, and product terminologies.

In the example, because multiple real-world entities may be identifiable by a same name, ingestion of information associated with mentions of an entity name requires entity stores to distinguish between different real world-entities identifiable by a same name and disambiguate the records stored in association different real-world entities identifiable by a same name. For entity stores to distinguish between different real-world entities identifiable by a same name, entity stores attempt to identify the mentions of the name element in other data sources and classify the mentions of the name element into categories that may or may not be pre-defined, but are assumed to correspond to different real-world entities that share a common name. For example, during ingestion of information by an entity store, a query for a particular name may result in discovery of two groups of discovered documents, where a first group refers to a first real-world entity from a first country with a first occupation and a second group refers to a second real-world entity from a second country with a second occupation. In another example, during ingestion of information by an entity store, the entity store may evaluate one or more of additional person names, organizations, occupations, locations, temporal expressions, and numerical expressions when initially identifying different groups of documents that are each assumed to correspond to different real world-entities that share a common name.

In one example, ingestion of information by an entity store may result in discovery of partial information about a named entity from other data sources and may result in multiple records with a same name element, and with different pieces of partial information about a same real-world entity. While a goal of an entity store is to ingest and aggregate all information received from one or more sources that belongs to a same entity into a single entity record, there are multiple factors that may lead to an entity store including multiple entity records that each have fragments of information about a same real-world entity or about different real-world entities with a same name element. For example, the information discovered by an entity store may not always contain the same unique entity identifiers that would enable matching the information correctly to the right entity record to create a single entity record for all information related to a same entity. If there is insufficient overlapping of the newly ingested information with information already stored in a record for an entity, the entity store may assume that a new real-world entity is referred to by a same name element and create a new record with the same name element for the new information. As a result, in response to ingesting and aggregating information from other sources, or at different times, entity store 140 may include multiple entity records with a same name element label, each with fragments of information about a same real-world entity or different real-world entities, such as entity record 142 and entity record 144. Further, for example, in response to ingesting information from other sources, or at different times, entity store 130 may include a single entity record of information with a particular name element label, such as entity record 132. In additional or alternate embodiments, each entity store may include additional or alternate entity records and may include one or more entity records with a same name element that are associated with a same real-world entity and may also include one or more entity records with a same name element that are associated with different real-world entities.

In particular, in one example, each entity store is populated and updated by ingesting and aggregating information from other structured and unstructured data sources at a single point in time or over multiple points in time. In one example, an entity store may manage population and updating in response to the results from search queries including a name element of a named entity and that may include additional information. In another example, an entity store manage population and updating by periodically receiving updated information for entities from one or more data sources. In one example, a structured data source may refer to the data that generally resides in a relational database and includes clearly defined data types that are easily searchable, such as data types that indicate a classification of a named entity. In one example, an unstructured data source may refer to data that is not structured by a predefined data model or schema or not stored in a relational database. For example, a document corpus of unstructured data in document corpus may include, but is not limited to, text files, emails, social media data, website data, text messages and other textual communications, media, and documents. In one example, the unstructured text documents included in a document corpus may have annotations for conference chains within the document, where the conference chains identify relationships between words in unstructured text.

To reduce the fragmentation of records with information about a same real-world entity in a single entity store, the entity store may apply one or more types of merging functions through a local merging controller, such as local merging controller 136 of entity store 130 and local merging controller 146 of entity store 140, to identify and merge information in different records that refer to a same real-world entity.

For example, local merging controller 136 and local merging controller 146 may apply an ingestion merging function where as a piece of information is ingested into an entity store, the local merging controller decides whether the information belongs to an existing entity record or if a new entity record needs to be created because the entity is not yet represented in the entity store. While an ingestion merging function may reduce the number of new entity records created for a same entity, not all information regarding an entity will have the same pieces of unique identifying information, such that an entity store may still create a new entity record for an entity to store a new piece of information even though an entity record for that entity already exists in the entity store, leading to fragments of information about a same entity in different entity records within the entity store. For example, during ingestion, local merging controller 146 may still create a new record, such as entity record 144 for an entity to store a new piece of information even though entity record 142 for that same entity already exists in the entity store. In addition, because each entity store may function as a separate database, with different implementation specifications and function interfaces, the effectiveness of the local ingestion merging function implemented by a particular entity store, in reducing entity record fragmentation in an entity store upon ingestion, may vary from entity store to entity store.

In addition, for example, local merging controller 136 and local merging controller 146 may apply a periodic merging function where the local merging controller periodically compares records within an entity store to one another and consolidates entity records when there is a sufficient level of overlapping information in each entity record. While a periodic merging function may reduce the number of fragments of information about a same entity in different entity records within an entity store, a periodic merging function within a single entity store requires a threshold amount of overlapping information within each entity record to support merges, and in practice, fragmented records with lower amounts of overlapping information may qualify for merging by the periodic merging function within a single entity store. For example, during period merging, local merging controller 146 may not detect a threshold amount of overlapping information across entity record 142 and entity record 144 to support merging the entity records, even though both entity records refer to the same entity. In addition, because each entity store may function as a separate database, with different implementation specifications and function interfaces, the effectiveness of the periodic ingestion merging function implemented by a particular entity store in periodically reducing entity record fragmentation in an entity store may vary from entity store to entity store.

According to an advantage of the present invention, a disambiguation controller 110 reduces the fragmentation of entity records in entity stores referring to a same entity by managing the identification and merging of overlapping records across multiple entity stores. Disambiguation controller 110 iteratively matches records across multiple entity stores that refer to a same entity and coordinates merging across entity stores that may have different implementation specifications and function interfaces, such that entity records with matching fragments across multiple entity stores are merged incrementally to reduce the fragmentation of entity records with information about a single entity across multiple entity stores. According to an advantage of the present invention, by disambiguation controller 110 managing a merging function across multiple entity stores, which may apply different implementation specifications and function interfaces, the amount of information available for overlapping across fragmented records increases, which also increases the probability of matching across different entity records above the probability of matching across different entity records in a single entity store. In addition, according to an advantage of the present invention, by disambiguation controller 110 managing a merging function across multiple entity stores, the bandwidth and other computing resources required for querying and modifying each entity store to aggregate fragmented entity records is efficiently applied to simultaneously improve the disambiguation of a named entity across multiple entity stores.

In the example, disambiguation controller 110 includes one or more components including, but not limited to, query controller 112, mapping controller 114, merging controller 116, and combination controller 118, for managing a reduction in fragmented entity records referring to a same entity across multiple entity stores. In additional or alternate embodiments, disambiguation controller 110 may include additional or alternate components. In the example illustrated, disambiguation controller 110 is illustrated as a service independent from a particular entity store, however, in additional or alternate embodiments, disambiguation controller 110 may function as a service of a particular entity store with access to other entity stores.

In the example, components of disambiguation controller 110 may manage calls to the function interfaces of and evaluate the responses from entity stores that may operate under different implementation specifications and function interfaces. In particular, entity store specifications and functional calls 124 includes specifications and call definitions for different entity stores, for enabling components of disambiguation controller 110 to communicate with entity stores with different specifications and functional calls. For example, one entity store may use a structured query language (SQL) based query syntax and another entity store may use a Lucene based query syntax, where components of disambiguation controller 110 manage calls to and evaluate responses from a particular entity store using the query syntax used by that entity store. In another example, one entity store may include a local merging controller with interfaces that can be called for directing the merging of records and another entity store may include a local merging controller that is triggered for merging of records by adding a temporary record to the entity store that will trigger the local merging of entity records.

In the example, disambiguation controller 110 initiates an aggregation of fragmented entity records referring to a same entity across multiple entity stores through a query controller 112. In the example, query controller 112 starts a process of querying an entity store serving as the query store, such as entity store 130, with one or more of a name element and other information about an entity, illustrated by an initial query 150. In response to initial query 150 of the query store, entity store 130 may return one or more results identifying entries in entity store 130, such as results including the information from entity record 132. For example, entity store may return query store results 152 identifying multiple entity records, each with one or more fragments of information matching the query.

In the example, a mapping controller 114 of merger controller 110 maps each entry in query store results 152 to any matching records in at least one other target entity store, such as entity store 140. In mapping to matching records, for each entry in query store results 152, mapping controller 114 may first query the target store with information from the query store entry, as a target store query by entry 156, and then determine whether there is sufficient overlap to qualify as a match between the information from the query store results entry and any record in target store results 158 returned from the target store. If the query store results entry does not match one or more records in target store results 158, mapping controller 114 moves to the next entry in the query store results. If the query store results entry matches multiple returned target store records, then disambiguation controller 110 triggers merging controller 116.

In the example, target store query by entry 156 includes information from entity record 132 that identifies an entity. In the example, if target store results 158 include entity record 142 and entity record 144, then mapping controller 114 determines whether there is sufficient overlap according to relevancy assessment 140 to match entity record 132 with each of entity record 142 and entity record 144. In the example, if mapping controller 114 determines there is sufficient overlap according to relevancy assessment 140, then merging controller 116 is triggered to manage merging of entity record 142 and entity record 144. In addition, mapping controller 114 records each match in a disambiguation record 122.

In one example, mapping controller 114 determines whether there is sufficient overlap by applying a relevancy assessment 120 that specifies a threshold level and type of overlap required to qualify as a match by mapping controller 114. In additional or alternate example, mapping controller 114 may apply additional or alternate types of rules and ranking functions to assess the likelihood that query results match to a same named entity.

In the example, in response to a matching determination by mapping controller 114, merging controller 116 manages merging of the multiple matching records from target store results 158. In particular, by mapping controller 114 determining that an entry in query store results 152 matches to multiple records in target store results 158, mapping controller 114 determines both that there is a match for an entity between the entity stores and that the records for the multiple matching records in target store results 158 refer to the same entity. In response to the mapping match, merging controller 116 triggers the target store to merge the multiple matching target store records to refer to the same entity, such as triggering entity store 140 to merge entity record 142 and entity record 144. In addition, merging controller 116 records the merger of the information in disambiguation record 122. In one example, according to an advantage of the invention, while the matching records in target store results 158 may not contain enough overlapping information by themselves to support local merging controller 146 initiating a merger of the matching records, the process of disambiguation controller 110 mapping records across multiple entity stores supports merging controller 116 directing local merging controller 146 to manage a merger to disambiguate the matching target store records based on information available from another entity store.

In another example, mapping controller 114 may also detect that multiple entries in query store results 152 match to a same record in target store results 158 in response to multiple queries to the target store recorded in disambiguation record 122. In response to mapping controller 116 detecting that multiple entries in query store results 152 match to a same record in target store results 158, mapping controller 114 triggers merging controller 116 to manage a merger of the matching records in query store results 152. Merging controller 116 triggers the query store to merge the matching records. In addition, merging controller 116 records the merger of the information in disambiguation record 122. In one example, according to an advantage of the invention, while the matching records in query store results 152 do not contain enough information by themselves to support local merging controller 136 initiating a merger of the matching records, the process of disambiguation controller 110 mapping records across multiple entity stores supports merging controller 116 directing local merging controller 136 to manage a merger to disambiguate the matching query store records based on information available from another entity store.

In one example, merging controller 116 may manage a merger of matching records according to the specifications and functions calls specified for the entity store, such as, but not limited, to calling a function of the respective local merging controller of the entity store to merge the matching records and submitting a query with the information in the matching records to the entity store to trigger the local merging controller to manage a merger of the same information in the matching entity records. In the example, each of local merging controller 136 and local merging controller 146 may apply one or more types of functions for aligning separate entity records into a single entity record with a same name element.

In the example, in response to mapping controller 114 and merging controller 116 completing mapping and merging based on all entries of query store results 152, disambiguation controller 110 may repeat the process initiated by query controller 112 for initial query 150 with the roles of the entity stores rotated so that one of the target entity stores becomes the query entity store and the query entity store becomes a target entity store.

In the example, in response to mapping controller 114 and merging controller 116 completing mapping and merging based on all entries in query store results 152 returned from one or more iterations of initial query 150, disambiguation controller 110 triggers combination controller 118 to coordinate internally merging records within each of the entity stores. For example, as a result of a merger of matching entity records in an entity store, the merged entity record may then include additional information that would support additional merges within the entity store that would not have been identified by the local merging controller prior to the merge managed across multiple entity stores. In one example, disambiguation record 122 includes records of the merged matching entity records for initial query 150. In one example, combination controller 118 manages local merging by creating a temporary record combining the mapped records from the query store and the target store recorded in disambiguation record 122 and calls the local merging controller of each entity store with the temporary record to determine if the externally driven mergers support additional internal mergers within each entity store.

In the example, disambiguation controller 110 may manage a process cycle of calling mapping controller 114, merger controller 116 and combination controller 118 multiple times for a same initial query 150. In the example, each time disambiguation controller 110 manages the process cycle for a same entity query, the records in the entity stores may become easier to merge because more information is available between entity stores on which to base merge decisions. In one example, an iteration count 128 records a number of iterations of the process cycle for a same entity query. In one example, disambiguation controller 110 may manage the process cycle for a same entity query for a fixed number of iterations set in iteration setting 126 by determining whether iteration count 128 has reached the fixed number of iterations. In another example, disambiguation controller 110 may repeat the process cycle for a same entity query until a stable configuration is reached where N or fewer merge steps are identified in a given iteration in disambiguation record 122, where if N is set to zero, then iteration continues until all merges are discovered, and where N is set in iteration setting 126.

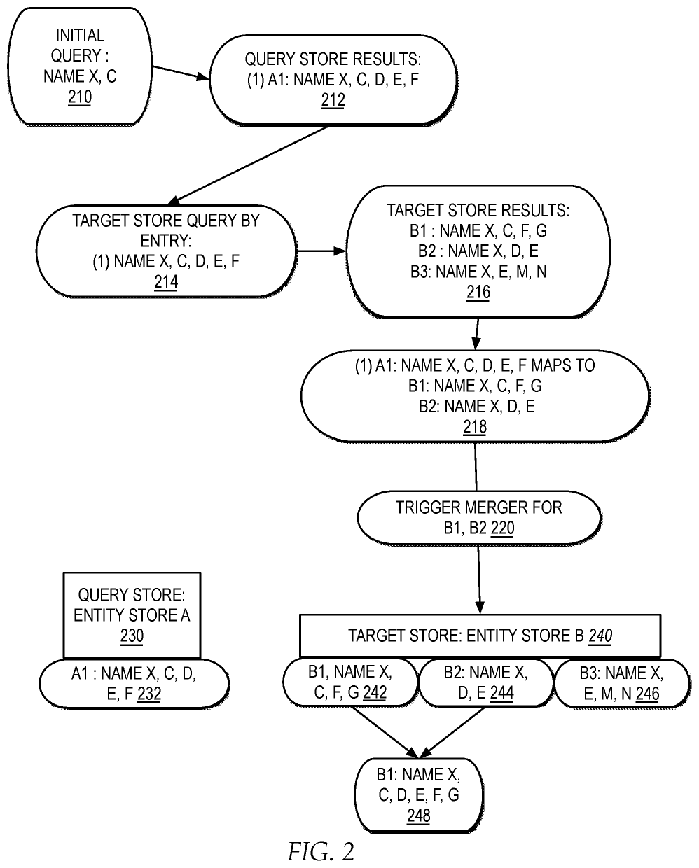

FIG. 2 illustrates one example of a disambiguation system discovering and merging entity record fragments in a target store that map to a query store record for improved named entity disambiguation.

In the example, an initial query 210 includes a name element of “name X” and an identifier component with information “C”. Query controller 112 submits initial query 210 to a query store 230, currently set to “entity store A”. As illustrated at reference numeral 232, query store 230 includes a record “A1” with a name element of “name X” and identifier components with information “C”, “D”, “E”, and “F” that is relevant to initial query 210.

As illustrated in the example, a set of query store results 212 returned by query store 230 to query controller 112 include a result identifying record “A1”, with a name element of “name X” and identifier components with information “C”, “D”, “E”, and “F”. In the example, based on query store results 212, mapping controller 114 creates a target store query by entry 214 with the name element and information extracted from the entry result of record “A1” and submits the query to a target store 240, currently set to “entity store B”. Target store 240 includes multiple records that may be relevant to target store query 214 including a record “B1” illustrated at reference numeral 242 with a name element of “name X” and identifier components with information “C”, “F”, and “G”, a record “B2” illustrated at reference numeral 244 with a name element of “name X” and identifier components with information “D” and “E”, and a record “B3” illustrated at reference numeral 246 with a name element of “name X” and identifier components with information “E”, “M”, and “N”.

Next, as illustrated in the example, a set of target store results 216 returned by target store 240 to mapping controller 114 include a result identifying each of record “B1”, “B2”, and “B3”. In the example, mapping controller 114 evaluates whether any of the records identified in target store results match the record in query store results 212. In the example, as illustrated at reference numeral 218, mapping controller 114 may evaluate that there is sufficient overlap of “name X” and information “C”, “D”, “E”, and “F” of record “A1” with “name X” and information “C”, “F”, and “G” of record “B1” to identify a match and of “name X” and with “name X” and information “D” and “E”, of record “B2” to identify a match, but not with “name X” and information “E”, “M” and “N” of record “B3”. In the example, in response to the mapping evaluation illustrated at reference numeral 218 including two records, merging controller 116 triggers target store 240 to merge records “B1” and “B2”, as illustrated at reference numeral 220. In the example, a local merging controller of target store 240 completes a merger of record “B1” and record “B2” in a merged record “B1” illustrated at reference numeral 248 with “name X” and information “C”, “D”, “E”, “F”, and “G”.

In the example, subsequent to merging controller 116 evaluating all merger options for query store results 212, combination controller 118 may trigger target store 240 to determine whether additional mergers may be performed internally within target store 240 in view of merged record “B1” as illustrated at reference numeral 248. In one example, in response to a trigger by combination controller 118 for merged record “B1” illustrated at reference numeral 248, the local merging controller of target store 240 may evaluate a merger of merged record “B1” illustrated at reference numeral 248 with record “B3” illustrated at reference numeral 246. In the example, while merged “B1” and “B3” include a same name element of “name X” and matching information “E”, local merging controller of target store 240 may determine that the overlapping type of information “E” is not sufficient or that there is not sufficient overlap of the other information in merged “B1” and “B3” to identify that the records are associated with the same real-world entity with the same name element.

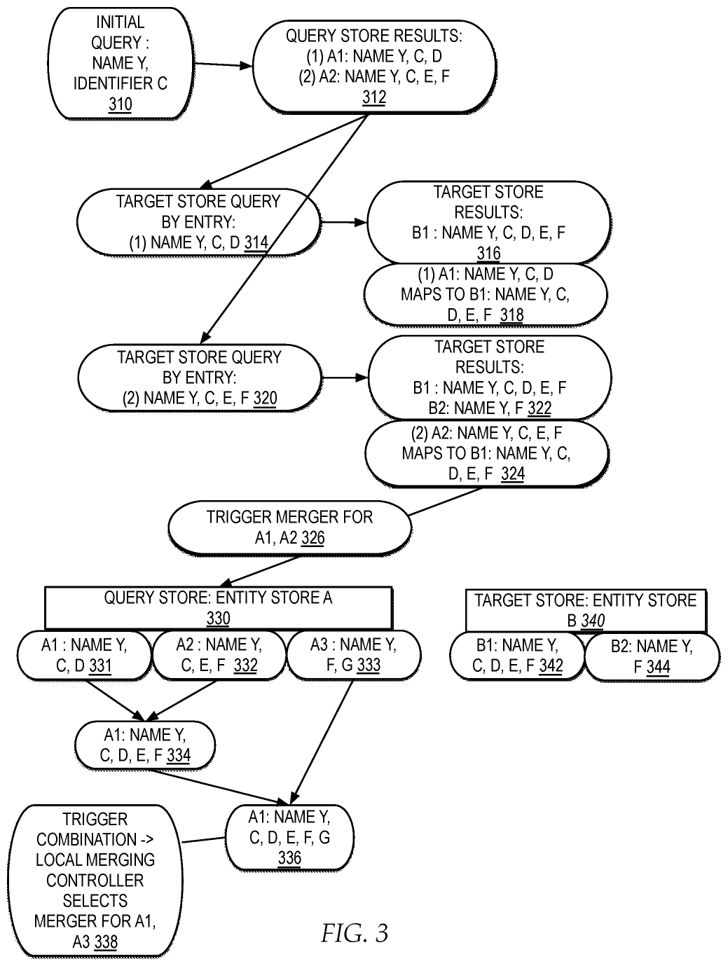

FIG. 3 illustrates one example of a disambiguation system discovering and merging entity record fragments in a query store that map to a target store record for improved named entity disambiguation.

In the example, an initial query 310 includes a name element of “name Y” and an identifier component with information “C”. Query controller 112 submits initial query 310 to a query store 330, currently set to “entity store A”. Query store 330 includes multiple records that may be relevant to initial query 310 illustrated as a record “A1” at reference numeral 331 with a name element of “name Y” and identifier components with information “C” and “D”, a record “A2” at reference numeral 332 with a name element of “name Y” and identifier components with information “C”, “E”, and “F”, and a record “A3” at reference numeral 333 with a name element of “name Y” and identifier components with information “F” and “G”.

As illustrated in the example, a set of query store results 312 returned by query store 330 to query controller 112 include a result identifying record “A1”, with a name element of “name Y” and identifier components with information “C” and “D” and a result identifying record “A2”, with a name element of “name Y” and identifier components with information “C”, “E”, and “F”.

In the example, based on query store results 312, mapping controller 114 creates a first target store query by entry 314 with the name element and information extracted from the entry result of record “A1” and submits the query to a target store 340, currently set to “entity store B”. Target store 340 includes multiple records that may be relevant to target store query 314 including a record “B1” illustrated at reference numeral 342, with a name element of “name Y” and identifier components with information “C”, “D”, “E”, and “F”, and a record “B2” illustrated at reference numeral 344, with a name element of “name Y” and an identifier component with information “F”.

Next, as illustrated in the example, a set of target store results 316 returned by target store 340 to mapping controller 114 include a result identifying only record “B1”. In the example, mapping controller 114 evaluates whether any of the records identified in target store results match the first entry record “A1” in query store results 312. In the example, as illustrated at reference numeral 318, mapping controller 114 may evaluate that there is sufficient overlap of “name Y” and information “C” and “D” of record “A1” with “name Y” and information “C”, “D”, “E” and “F” of record “B1” to identify a single match.

In the example, based on query store results 312, mapping controller 114 creates a second target store query by entry 320 with the name element and information extracted from the entry result of record “A2” and submits the query to target store 340. Next, as illustrated in the example, a set of target store results 322 returned by target store 340 to mapping controller 114 include a result identifying both record “B1” and “B2”, which match with the name and one or more of the information components in target store query 320. In the example, mapping controller 114 evaluates whether any of the records identified in target store results match the second entry record “A2” in query store results 312. In the example, as illustrated at reference numeral 324, mapping controller 114 may evaluate that there is sufficient overlap of “name Y” and information “C”, “E”, and “F” of record “A2” with “name Y” and information “C”, “D”, “E” and “F” of record “B1” to identify a match, but not sufficient overlap of record “A2” with record “B2” to identify a match.

In the example, in response to the mapping evaluation illustrated at reference numeral 318 and reference numeral 324, although no single mapping evaluation includes multiple records, there are multiple mapping evaluations that map a same target store record to multiple query store records, merging controller 116 triggers query store 300 to merge records “A1” and “A2”, as illustrated at reference numeral 326. In the example, a local merging controller of query store 330 completes a merger of record “A1” and record “A2” in a merged record “A1” illustrated at reference numeral 334 with “name Y” and information “C”, “D”, “E”, and “F”.

In the example, subsequent to merging controller 116 evaluating all merger options for query store results 312, combination controller 118 may trigger query store 330 to determine whether additional mergers may be performed internally within query store 330 in view of merged record “A1” as illustrated at reference numeral 334. In one example, in response to a trigger by combination controller 118 for merged record “A1” illustrated at reference numeral 334, the local merging controller of query store 330 may evaluate a merger of merged record “A1” illustrated at reference numeral 334 with record “A3” illustrated at reference numeral 333. In the example, merged “A1” and “A3” include a same name element of “name Y” and matching information F″, where local merging controller of query store 330 may determine that the overlapping type of information “F” is sufficient to identify that the records are associated with the same real-world entity with the same name element. As illustrated at reference numeral 338, combination controller 116 may trigger the local merging controller with selects to a merger for records “A1” and “A3” in a merged “A1” record as illustrated at reference numeral 336 including the name element of “name Y” and information “C”, “D”, “E”, “F”, and “G”.

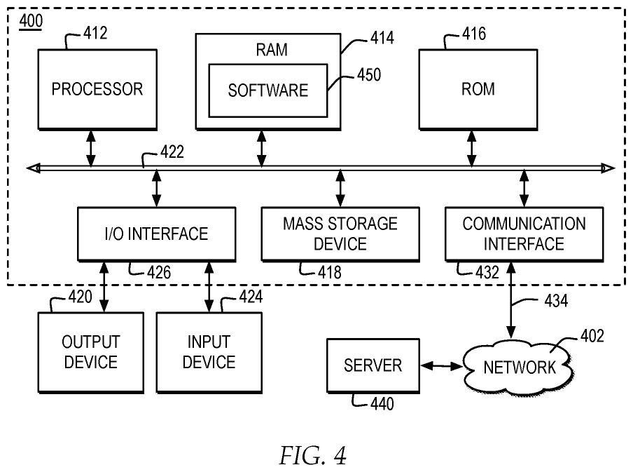

FIG. 4 illustrates a block diagram of one example of a computer system in which one embodiment of the invention may be implemented. The present invention may be performed in a variety of systems and combinations of systems, made up of functional components, such as the functional components described with reference to a computer system 400 and may be communicatively connected to a network, such as network 402.

Computer system 400 includes a bus 422 or other communication device for communicating information within computer system 400, and at least one hardware processing device, such as processor 412, coupled to bus 422 for processing information. Bus 422 preferably includes low-latency and higher latency paths that are connected by bridges and adapters and controlled within computer system 400 by multiple bus controllers. When implemented as a server or node, computer system 400 may include multiple processors designed to improve network servicing power.

Processor 412 may be at least one general-purpose processor that, during normal operation, processes data under the control of software 450, which may include at least one of application software, an operating system, middleware, and other code and computer executable programs accessible from a dynamic storage device such as random access memory (RAM) 414, a static storage device such as Read Only Memory (ROM) 416, a data storage device, such as mass storage device 418, or other data storage medium. Software 450 may include, but is not limited to, code, applications, protocols, interfaces, and processes for controlling one or more systems within a network including, but not limited to, an adapter, a switch, a server, a cluster system, and a grid environment.

Computer system 400 may communicate with a remote computer, such as server 440, or a remote client. In one example, server 440 may be connected to computer system 400 through any type of network, such as network 402, through a communication interface, such as network interface 432, or over a network link that may be connected, for example, to network 402.

In the example, multiple systems within a network environment may be communicatively connected via network 402, which is the medium used to provide communications links between various devices and computer systems communicatively connected. Network 402 may include permanent connections such as wire or fiber optics cables and temporary connections made through telephone connections and wireless transmission connections, for example, and may include routers, switches, gateways and other hardware to enable a communication channel between the systems connected via network 402. Network 402 may represent one or more of packet-switching based networks, telephony-based networks, broadcast television networks, local area and wire area networks, public networks, and restricted networks.

Network 402 and the systems communicatively connected to computer 400 via network 402 may implement one or more layers of one or more types of network protocol stacks which may include one or more of a physical layer, a link layer, a network layer, a transport layer, a presentation layer, and an application layer. For example, network 402 may implement one or more of the Transmission Control Protocol/Internet Protocol (TCP/IP) protocol stack or an Open Systems Interconnection (OSI) protocol stack. In addition, for example, network 402 may represent the worldwide collection of networks and gateways that use the TCP/IP suite of protocols to communicate with one another. Network 402 may implement a secure HTTP protocol layer or other security protocol for securing communications between systems.

In the example, network interface 432 includes an adapter 434 for connecting computer system 400 to network 402 through a link and for communicatively connecting computer system 400 to server 440 or other computing systems via network 402. Although not depicted, network interface 432 may include additional software, such as device drivers, additional hardware and other controllers that enable communication. When implemented as a server, computer system 400 may include multiple communication interfaces accessible via multiple peripheral component interconnect (PCI) bus bridges connected to an input/output controller, for example. In this manner, computer system 400 allows connections to multiple clients via multiple separate ports and each port may also support multiple connections to multiple clients.

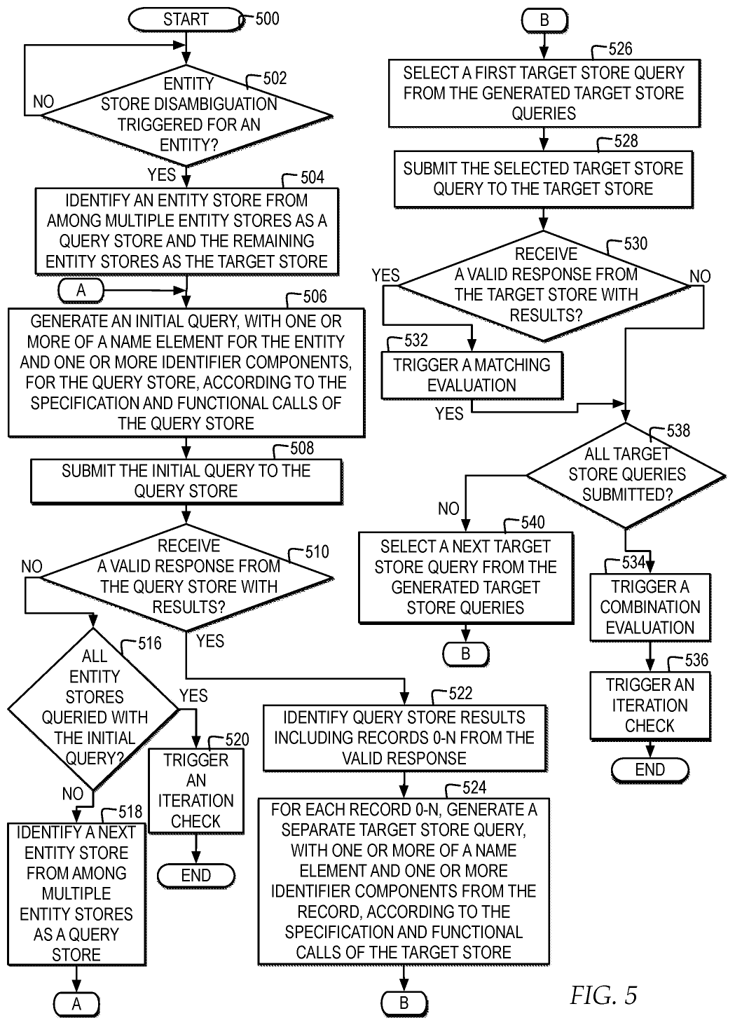

In one embodiment, the operations performed by processor 412 may control the operations of flowchart of FIGS. 5-8 and other operations described herein. Operations performed by processor 412 may be requested by software 450 or other code or the steps of one embodiment of the invention might be performed by specific hardware components that contain hardwired logic for performing the steps, or by any combination of programmed computer components and custom hardware components. In one embodiment, one or more components of computer system 400, or other components, which may be integrated into one or more components of computer system 400, may contain hardwired logic for performing the operations of flowcharts in FIGS. 5-8.

In addition, computer system 400 may include multiple peripheral components that facilitate input and output. These peripheral components are connected to multiple controllers, adapters, and expansion slots, such as input/output (I/O) interface 426, coupled to one of the multiple levels of bus 422. For example, input device 424 may include, for example, a microphone, a video capture device, an image scanning system, a keyboard, a mouse, or other input peripheral device, communicatively enabled on bus 422 via I/O interface 426 controlling inputs. In addition, for example, output device 420 communicatively enabled on bus 422 via I/O interface 426 for controlling outputs may include, for example, one or more graphical display devices, audio speakers, and tactile detectable output interfaces, but may also include other output interfaces. In alternate embodiments of the present invention, additional or alternate input and output peripheral components may be added.

With respect to FIG. 4, the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those of ordinary skill in the art will appreciate that the hardware depicted in FIG. 4 may vary. Furthermore, those of ordinary skill in the art will appreciate that the depicted example is not meant to imply architectural limitations with respect to the present invention.

FIG. 5 illustrates a high-level logic flowchart of a process and computer program for managing an entity disambiguation by discovering and merging entity record fragments of a same entity across multiple entity stores.

In one example, the process and program starts at block 500 and thereafter proceeds to block 502. Block 502 illustrates a determination whether an entity store disambiguation is triggered for an entity. At block 502, if an entity store disambiguation is triggered for an entity, then the process passes to block 504. Block 504 illustrates identifying an entity store from among multiple entity stores as a query store and the remaining entity stores as the target store. Next, block 506 illustrates generating an initial query, with one or more of a name identifier for the entity and one or more identifier components, for the query store, according to the specification and functional calls of the query store. Thereafter, block 508 illustrates submitting the initial query to the query store, and the process passes to block 510.

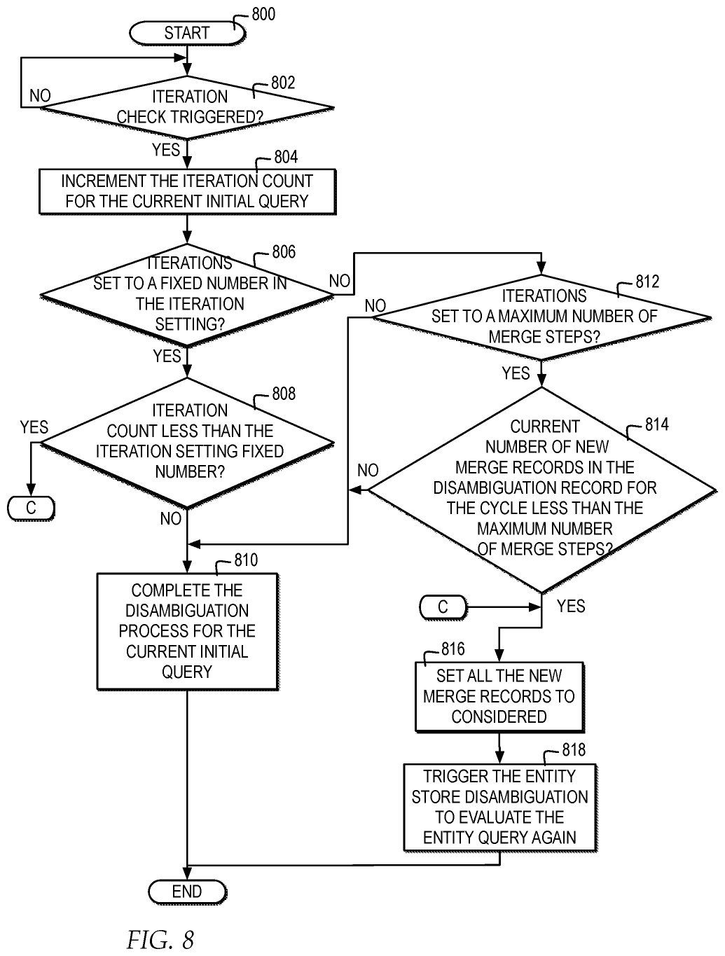

Block 510 illustrates a determination whether a valid response is received from the query store with the results. At block 510, if a valid response is not received, then the process passes to block 516. Block 516 illustrates a determination whether all entity stores have been queried with the initial query. At block 516, if not all entity stores have been queried with the initial query, then the process passes to block 518. Block 518 illustrates identifying a next entity store from among the multiple entity stores as a query store, and the process returns to block 506. Returning to block 516, if all entity stores have been queried with the initial query, then the process passes to block 520. Block 520 illustrates triggering an iteration check, which triggers the process illustrated in FIG. 8, and the process ends.

Returning to block 510, if a valid response is received from the query store with the results, then the process passes to block 522. Block 522 illustrates identifying query store results including records 0-N from the valid response. Next, block 524 illustrates, for each record 0-N, generating a separate target store query with one or more of a name element and one or more identifier components from the record, according to the specification and functional calls of the target store, and the process passes to block 526.

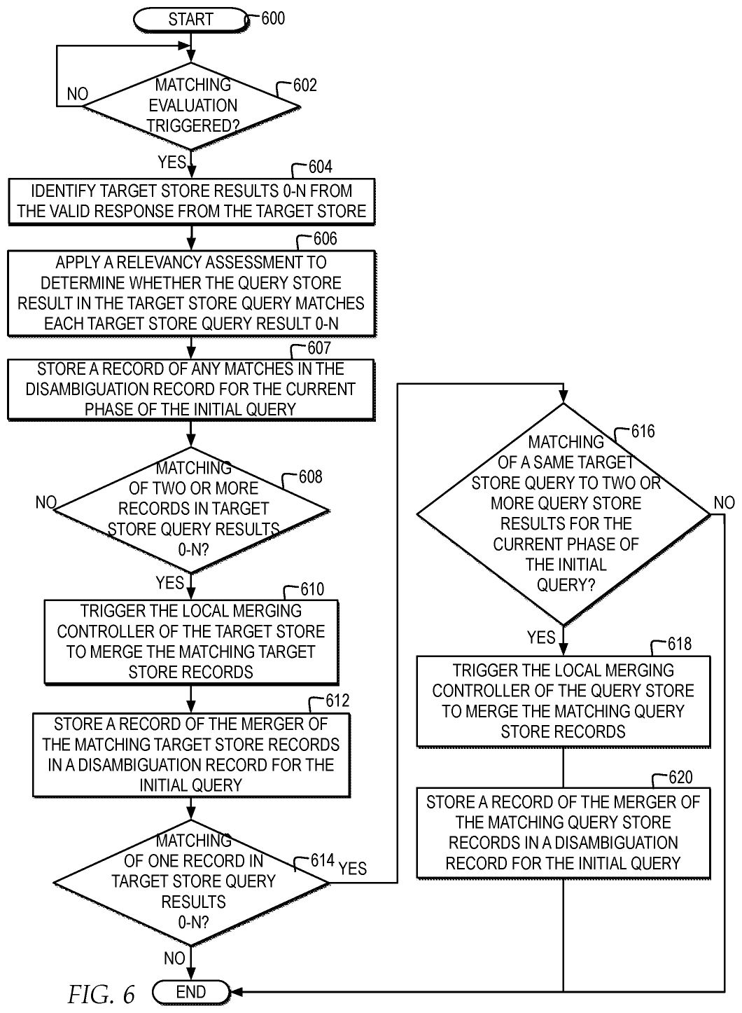

Block 526 illustrates selecting a first target store query from the generated target store queries. Next, block 528 illustrates submitting the selected target store query to the target store. Thereafter, block 530 illustrates a determination whether a valid response is received from the target store with results. At block 530, if a valid response with results is received, then the process passes to block 532. Block 532 illustrates triggering a matching evaluation, which triggers the process illustrated in FIG. 6, and the process passes to block 538. Returning to block 530, if no valid response with results is received, then the process passes to block 538.

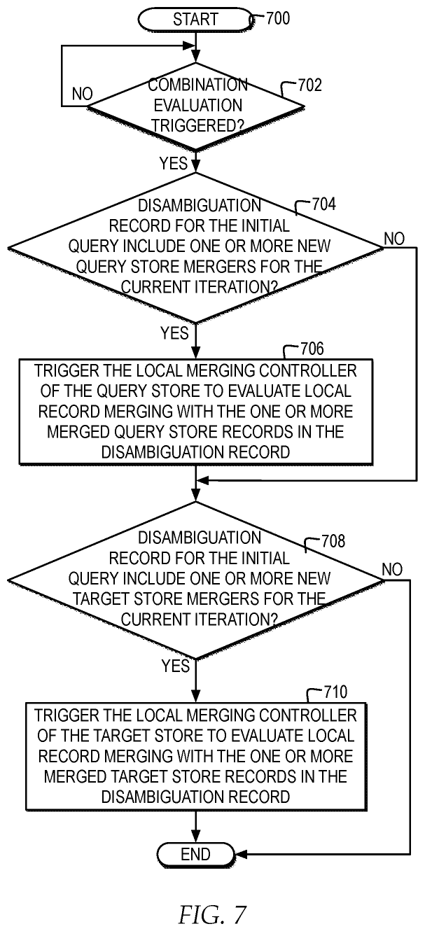

Block 538 illustrates a determination whether all target store queries are submitted. At block 538, if not all target store queries have been submitted, then the process passes to block 540. Block 540 illustrates selecting a next target store query from the generated target store queries, and the process passes to block 526. Returning to block 538, if all target store queries have been submitted, then the process passes to block 534. Block 534 illustrates triggering a combination evaluation, which triggers the process illustrated in FIG. 7. Next, block 536 illustrates triggering an iteration check, which triggers the process illustrated in FIG. 8, and the process ends.

FIG. 6 illustrates a high-level logic flowchart of a process and computer program for evaluating whether a query store record matches a target store record across multiple entity stores for managing entity disambiguation across multiple entity stores.

In one example, the process and program starts at block 600 and thereafter proceeds to block 602. Block 602 illustrates a determination whether a matching evaluation is triggered for a particular target store query and the results of the target store query. At block 602, if a matching evaluation is triggered, then the process passes to block 604. Block 604 illustrates identifying the target store results 0-N from the valid response from the target store. Next, block 606 illustrates applying a relevancy assessment to determine whether the query store result in the target store query matches each target store query result 0-N. Thereafter, block 607 illustrates storing a record of any matches in the disambiguation record for the current phase of the initial query, and the process passes to block 608.

Block 608 illustrates a determination whether two or more records in the target store query results 0-N match the query store result. At block 608, if two or more records match, then the process passes to block 610. Block 610 illustrates triggering the local merging controller of the target store to merge the matching target store records. Next, block 612 illustrates storing a record of the merger of the matching target store records in a disambiguation record for the initial query, and the process passes to block 614. Returning to block 608, if two or more records do not match, then the process passes to block 614.

Block 614 illustrates a determination whether one record in the target store query results 0-N matches the query store result. At block 614, if no record matches, then the process ends, and returns to the process in FIG. 5. At block 614, if a record matches, then the process passes to block 616. Block 616 illustrates a determination whether a same target store query result has matched to two or more query store results as recorded in the disambiguation record for the current phase of the initial query. At block 616, if a same target store query result does not match to two or more query store results, then the process ends. At block 616, if a same target store query result does match to two or more query store results, then the process passes to block 618. Block 618 illustrates triggering the local merging controller of the query store to merge the matching query store records. Next, block 620 illustrates storing a record of the merger of the matching query store records in a disambiguation record for the initial query, and the process ends.

FIG. 7 illustrates a high-level logic flowchart of a process and computer program for managing a combination phase to coordinate triggering entity stores to internally evaluate merging records subsequent to a disambiguation system managing an externally triggered merging of records within the entity stores.

In the example, the process and program starts at block 700 and thereafter proceeds to block 702. Block 702 illustrates a determination whether a combination evaluation is triggered. At block 702, if a combination evaluation is triggered, then the process passes to block 704. Block 704 illustrates a determination whether a disambiguation record for the initial query includes one or more new query store mergers for the current iteration. At block 704, if a disambiguation record for the initial query does not include one or more new query store mergers for the current iteration, then the process passes to block 708. Returning to block 704, if a disambiguation record for the initial query includes one or more new query store mergers for the current iteration, then the process passes to block 706. Block 706 illustrates triggering the local merging controller of the query store to evaluate local record merging with the one or more merged query store records in the disambiguation record, and the process passes to block 708.

Block 708 illustrates a determination whether a disambiguation record for the initial query includes one or more new target store mergers for the current iteration. At block 710, if a disambiguation record for the initial query does not include one or more new target store mergers for the current iteration, then the process ends and returns to the triggering process in FIG. 5. Returning to block 708, if a disambiguation record for the initial query includes one or more new target store mergers for the current iteration, then the process passes to block 710. Block 710 illustrates triggering the local merging controller of the target store to evaluate local record merging with the one or more merged target store records in the disambiguation record, and the ends and returns to the triggering process in FIG. 5.

FIG. 8 illustrates a high-level logic flowchart of a process and computer program for determining whether to trigger an additional iteration of a disambiguation evaluation for a current entity query.

In the example, the process and program starts at block 800, and thereafter proceeds to block 802. Block 802 illustrates a determination whether an iteration check is triggered. At block 802, if an iteration check is triggered, then the process passes to block 804. Block 804 illustrates incrementing the iteration count for the current initial query. Next, block 806 illustrates a determination whether the iterations are set to a fixed number in the iteration setting. At block 806, if the iterations are set to a fixed number in iteration setting, then the process passes to block 808.

Block 808 illustrates a determination whether the iteration count is less than the iteration setting fixed number. At block 808, if the iteration count is not less than the iteration setting fixed number, then the process passes to block 810. Block 810 illustrates completing the disambiguation process for the current initial query, and the process ends. Returning to block 808, if the iteration count is less than the iteration setting fixed number, then the process passes to block 816. Block 816 illustrates setting all the new merge records as considered. Next, block 818 illustrates triggering the entity store disambiguation to process the entity query again, which triggers block 502 of FIG. 5, and the process ends.

Returning to block 806, if the iterations are not set to a fixed number in iteration setting, then the process passes to block 812. Block 812 illustrates a determination whether the current number of new merge records in the disambiguation record for the cycle is less than the maximum number of merge steps.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification specify the presence of stated features, integers, steps, operations, elements, and/or components, but not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the one or more embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the invention has been particularly shown and described with reference to one or more embodiments, it will be understood by those skilled in the art that various changes in form and detail may be made therein without departing from the spirit and scope of the invention.

What is claimed is:

1. A method comprising:
receiving, by a computer system, from a query entity store, a query store result in response to an initial query referencing at least one of a name element and a first identifier component related to an entity, the query store result comprising a query store record comprising information related to the entity;
receiving, by the computer system, from a target entity store, a target store result to a target store query referencing the query store record, the target store result comprising one or more target store records related to the information found in the query store record;
comparing, by the computer system, the one or more target store records to the information in the query store record; and
responsive to determining a relevancy assessment indicates a match between the information in the query store record and two or more particular target store records from among the one or more target store records, triggering, by the computer system, the target entity store to merge the two or more particular target store records.

2. The method according to claim 1, further comprising:
for a first phase of an evaluation of the initial query, setting, by the computer system, a first entity store as the query entity store and a second entity store as the target entity store; and
for a second phase of the evaluation of the initial query, setting, by the computer system, the second entity store as the query entity store and the first entity store as the target entity store.

3. The method according to claim 1, further comprising:
responsive to completing an iteration of an evaluation of the initial query, incrementing, by the computer system, an iteration counter for the initial query; and
responsive to the iteration counter set to less than an iteration fixed number, triggering, by the computer system, an additional iteration of the evaluation of the initial query.

4. The method according to claim 1, further comprising:
responsive to completing an iteration of an evaluation of the initial query, detecting, by the computer system, a number of mergers triggered during the iteration; and
responsive to a number of mergers triggered less than a set maximum number of merge steps, triggering, by the computer system, an additional iteration of the evaluation of the initial query.

5. The method according to claim 1, further comprising:
responsive to receiving a trigger for an entity store disambiguation for an entity, generating, by the computer system, the initial query with at least one of the name element and a first identifier component related to the entity according to a specification and functional call of the query entity store; and
submitting, by the computer system, the initial query to the query entity store.

6. The method according to claim 1, further comprising:
responsive to the query store result comprising a plurality of separate query store records comprising information related to the entity, submitting, by the computer system, to the target entity store a separate target store query of a plurality of target store queries each refencing a respective separate query store record of the plurality of separate query store records; and
responsive to completing a separate relevancy assessment for the results of each separate target store query with the respective separate query store record and triggering at least one merger by the target store entity of a respective selection of two or more target store records, triggering, by the computer system, the target store entity to internally evaluate whether merge a plurality of target store records related to the entity.

7. The method according to claim 1, further comprising:
responsive to the query store result comprising a plurality of separate query store records each comprising respective information related to the entity, submitting, by the computer system, to the target entity store a separate target store query of a plurality of target store queries each refencing a respective separate query store record of the plurality of separate query store records; and
responsive to determining the relevancy assessment indicates a match between a particular target store record returned in response two or more of the plurality of target store queries and the respective information in two or more particular query store records of the plurality of query store records, triggering, by the computer system, the query entity store to merge the two or more particular query store records.

8. A computer system comprising one or more processors, one or more computer-readable memories, one or more computer-readable storage devices, and program instructions, stored on at least one of the one or more storage devices for execution by at least one of the one or more processors via at least one of the one or more memories, the stored program instructions comprising:
program instructions to receive, from a query entity store, a query store result in response to an initial query referencing at least one of a name element and a first identifier component related to an entity, the query store result comprising a query store record comprising information related to the entity;
program instructions to receive, from a target entity store, a target store result to a target store query referencing the query store record, the target store result comprising one or more target store records related to the information found in the query store record;
program instructions to compare the one or more target store records to the information in the query store record; and
program instructions, responsive to determining a relevancy assessment indicates a match between the information in the query store record and two or more particular target store records from among the one or more target store records, to trigger the target entity store to merge the two or more particular target store records.

9. The computer system according to claim 8, the program instructions further comprising:
program instructions, for a first phase of an evaluation of the initial query, to set a first entity store as the query entity store and a second entity store as the target entity store; and
program instructions, for a second phase of the evaluation of the initial query, to set the second entity store as the query entity store and the first entity store as the target entity store.

10. The computer system according to claim 8, the program instructions further comprising:
program instructions, responsive to completing an iteration of an evaluation of the initial query, to increment an iteration counter for the initial query; and
program instructions, responsive to the iteration counter set to less than an iteration fixed number, to trigger an additional iteration of the evaluation of the initial query.

11. The computer system according to claim 8, the program instructions further comprising:
program instructions, responsive to completing an iteration of an evaluation of the initial query, to detect a number of mergers triggered during the iteration; and
program instructions, responsive to a number of mergers triggered less than a set maximum number of merge steps, to trigger an additional iteration of the evaluation of the initial query.

12. The computer system according to claim 8, the program instructions further comprising:
program instructions, responsive to receiving a trigger for an entity store disambiguation for an entity, to generate the initial query with at least one of the name element and a first identifier component related to the entity according to a specification and functional call of the query entity store; and
program instructions to submit the initial query to the query entity store.

13. The computer system according to claim 8, the program instructions further comprising:
program instructions, responsive to the query store result comprising a plurality of separate query store records comprising information related to the entity, to submit to the target entity store a separate target store query of a plurality of target store queries each refencing a respective separate query store record of the plurality of separate query store records; and
program instructions, responsive to completing a separate relevancy assessment for the results of each separate target store query with the respective separate query store record and triggering at least one merger by the target store entity of a respective selection of two or more target store records, to trigger the target store entity to internally evaluate whether merge a plurality of target store records related to the entity.

14. The computer system according to claim 8, the program instructions further comprising:
program instructions, responsive to the query store result comprising a plurality of separate query store records each comprising respective information related to the entity, to submit to the target entity store a separate target store query of a plurality of target store queries each refencing a respective separate query store record of the plurality of separate query store records; and
program instructions, responsive to determining the relevancy assessment indicates a match between a particular target store record returned in response two or more of the plurality of target store queries and the respective information in two or more particular query store records of the plurality of query store records, to trigger the query entity store to merge the two or more particular query store records.

15. A computer program product comprises one or more computer readable storage media having program instructions collectively stored thereon, wherein the one or more computer readable storage media are not a transitory signal per se, the program instructions executable by a computer to cause the computer to:
receive, by a computer, from a query entity store, a query store result in response to an initial query referencing at least one of a name element and a first identifier component related to an entity, the query store result comprising a query store record comprising information related to the entity;
receive, by the computer, from a target entity store, a target store result to a target store query referencing the query store record, the target store result comprising one or more target store records related to the information found in the query store record;
compare, by the computer, the one or more target store records to the information in the query store record; and
responsive to determining a relevancy assessment indicates a match between the information in the query store record and two or more particular target store records from among the one or more target store records, trigger, by the computer, the target entity store to merge the two or more particular target store records.

16. The computer program product according to claim 15, further comprising the program instructions executable by the computer to cause the computer to:
for a first phase of an evaluation of the initial query, set, by the computer, a first entity store as the query entity store and a second entity store as the target entity store; and
for a second phase of the evaluation of the initial query, set, by the computer, the second entity store as the query entity store and the first entity store as the target entity store.

17. The computer program product according to claim 15, further comprising the program instructions executable by the computer to cause the computer to:
responsive to completing an iteration of an evaluation of the initial query, increment, by the computer, an iteration counter for the initial query; and
responsive to the iteration counter set to less than an iteration fixed number, trigger, by the computer, an additional iteration of the evaluation of the initial query.

18. The computer program product according to claim 15, further comprising the program instructions executable by the computer to cause the computer to:
responsive to completing an iteration of an evaluation of the initial query, detect, by the computer, a number of mergers triggered during the iteration; and
responsive to a number of mergers triggered less than a set maximum number of merge steps, trigger, by the computer, an additional iteration of the evaluation of the initial query.

19. The computer program product according to claim 15, further comprising the program instructions executable by the computer to cause the computer to:
responsive to receiving a trigger for an entity store disambiguation for an entity, generate, by the computer, the initial query with at least one of the name element and a first identifier component related to the entity according to a specification and functional call of the query entity store; and
submit, by the computer, the initial query to the query entity store.

20. The computer program product according to claim 15, further comprising the program instructions executable by the computer to cause the computer to:
responsive to the query store result comprising a plurality of separate query store records comprising information related to the entity, submit, by the computer, to the target entity store a separate target store query of a plurality of target store queries each refencing a respective separate query store record of the plurality of separate query store records; and
responsive to completing a separate relevancy assessment for the results of each separate target store query with the respective separate query store record and triggering at least one merger by the target store entity of a respective selection of two or more target store records, trigger, by the computer, the target store entity to internally evaluate whether merge a plurality of target store records related to the entity.
